(19) United States
(12) Patent Application Publication
(10) Pub. No.: US 2026/0317083 A1
(43) Pub. Date: Oct. 15, 2026

(54) PICKING AND POSITIONING SYSTEM WITH COMMAND MEANS

(71) Applicant: MARCHESINI GROUP S.P.A., Pianoro (Bologna) (IT)

(72) Inventor: Simone NANNETTI, Pianoro (Bologna) (IT)

(21) Appl. No.: 19/117,137

(22) PCT Filed: Jun. 28, 2023
(86) PCT No.: PCT/IB2023/056674

§ 371 Date: Mar. 31, 2025

(30) Foreign Application Priority Data
Oct. 27, 2022 (IT) 102022000022173

(51) Int. Cl. B65G 47/91

(52) U.S. Cl. CPC B65G 47/915

(57) ABSTRACT

A picking and positioning system of products for a plant having a transport system and an operating system, suitable for engaging the products in a first position to move and position the products in a second position, has a base group having a base body, extending along a first axis, and a gripping group, extending along a second axis, and having a gripping device having a gripping element engaging a product. Command devices, commanding the base and gripping groups in movement and the gripping element, and the product from the first position to the second position, have a first device that moves the base body, a second device that moves the gripping group, and transmission members which transform a rotary action of the first device into a rotary action of the second device so that a rotation of the gripping group is simultaneous with a rotation of the base group.

The present invention relates to a picking and positioning system of products for a plant. Additionally, the present invention relates to a plant that comprises said products picking and positioning system.

Plants that are suitable for performing a series of operations for producing food or cosmetic or pharmaceutical products are known in the prior art.

Specifically, embodiments are known in which the products comprise a container made from a plastic material or a metallic material or glassy material or a paper material or else a combination of said materials. Furthermore, embodiments are known wherein the products comprise a container made from a solid material or else a soft material.

In the present disclosure, in fact, the term ‘product’ is understood to mean a generic product for example in the form of a tube, or in the form of a blister pack, or in the form of a pouch, or in a box shape.

The plants are suitable for performing specific operations on products such as the creation of the container, for example by carrying out bending and/or welding operations but also container filling operations and the like.

The known plants comprise specific systems wherein each thereof is suitable for carrying out appropriate movements and/or operations.

For example, the known plants comprise transport systems that are suitable for moving the products. Said transport systems are suitable for performing individualized operations for moving the products in a discretized manner. According to a preferred embodiment, the products are arranged in a substantially horizontal position in the transport systems.

Furthermore, the known plants comprise operating systems that are suitable for carrying out one or more operations on the product: for example, cleaning, folding, bending, welding and marking. Preferably, in operating systems the products are arranged in a substantially vertical position, in such a manner as to be able to carry out one or more of the aforementioned operations, preferably within a region that is proximal to an axial end of the product. In certain embodiments, the operating systems comprise mobile systems that are suitable for moving the product into distinct operating stations in order to perform distinct operations.

In the plants, the passage of a product from the transport system to the operating system by specific picking and positioning systems that are suitable for picking the product from the transport system in order to move it into the operating system.

According to a preferred embodiment, the picking and positioning system picks the product from a substantially horizontal position in order to position it in a substantially vertical position. According to a further preferred embodiment, the picking and positioning system picks the product from a substantially vertical position in order to position it in a substantially horizontal position. Furthermore, according to other preferred embodiments, the picking and positioning system picks the product from a substantially horizontal position in order to position it in a different substantially horizontal position.

The known plants are researched and used for producing thousands of products, therefore the number of single operations/movements performed by the distinct systems is therefore extremely high.

With particular reference to the picking and positioning system, it is required that the picking and positioning operations be performed with a high level of reproducibility, safety, cleanliness, precision and speed. At the same time, one of the most important requirements s the fact that, in order to adapt themselves to the characteristics of the product, the picking and positioning system should be extremely versatile. Furthermore, it is also requested that the picking and positioning system has dimensions that are as compact as possible.

In the state of the art, picking and positioning system solutions are known in which, at best, only one of the aforementioned requests is performed, sacrificing the others. For example, solutions are known for picking and positioning systems with remarkable speed but poor flexibility. Also known are solutions for picking and positioning systems with remarkable flexibility but with a compromised level of safety and cleanliness.

The object of the present invention is that of efficiently resolving the aforesaid situation by proposing a picking and positioning system that may effectively fulfill all of the necessary requirements.

This object is achieved with the picking and positioning system claimed in claim 1. Additionally, this object is achieved with the plant according to claim 14. The claims dependent on these request protection for further features and entail further technical benefits.

In addition, further features and advantages of the invention will become clear from the description provided below of preferred embodiments thereof given as non-limiting examples with reference to the attached figures, in which:

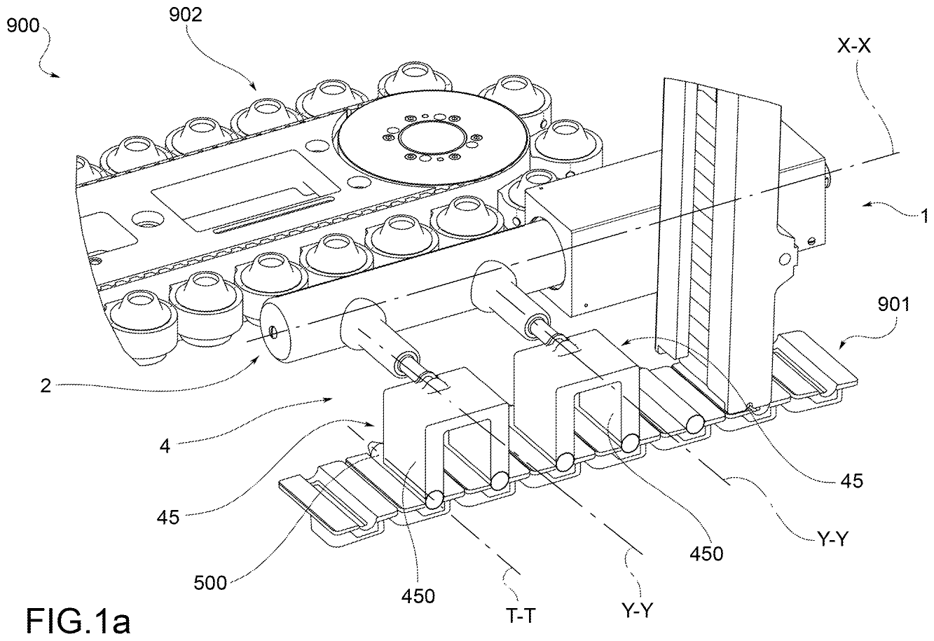

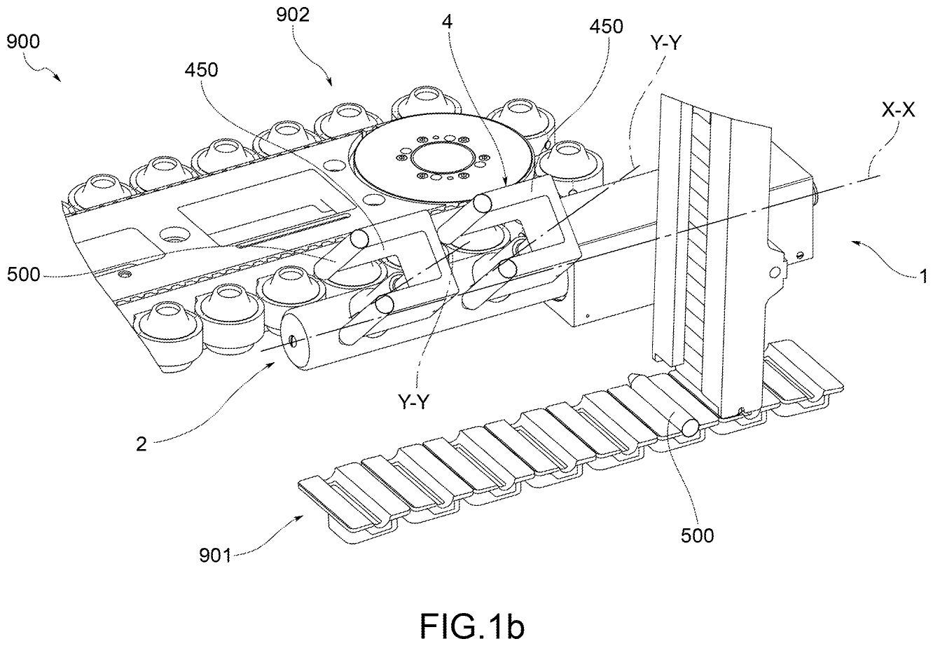

FIGS. 1a, 1b, 1c and 1d show, in perspective, a plant, respectively in a first position (or picking position), a first intermediate position, a second intermediate position and a second position (or positioning position or depositing position) according to the present invention, according to a first embodiment;

FIGS. 1a′, 1b′, 1c′ and 1d′ show some side views of the plant shown in FIGS. 1a, 1b, 1c and 1d;

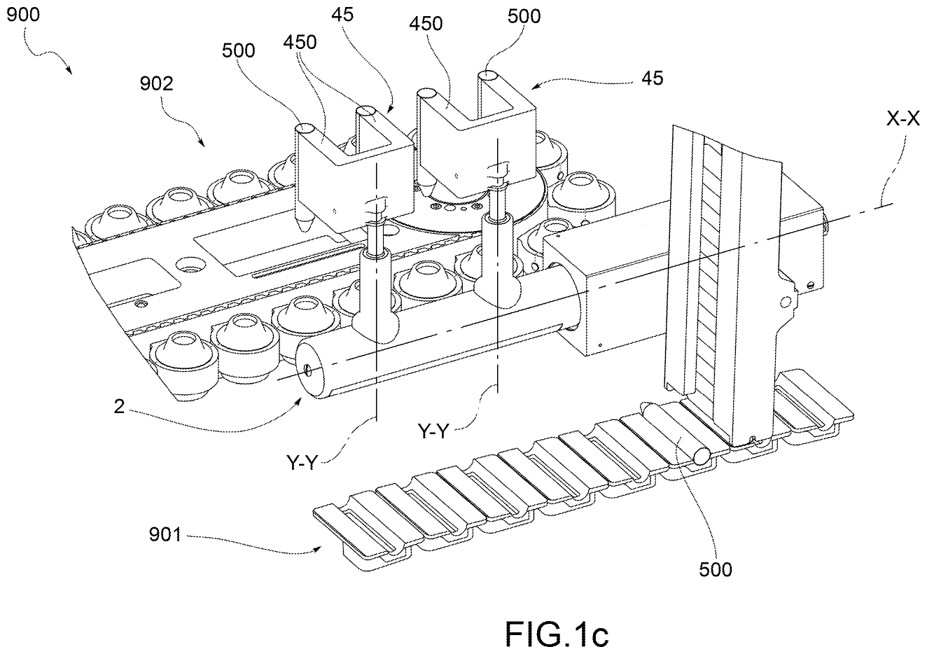

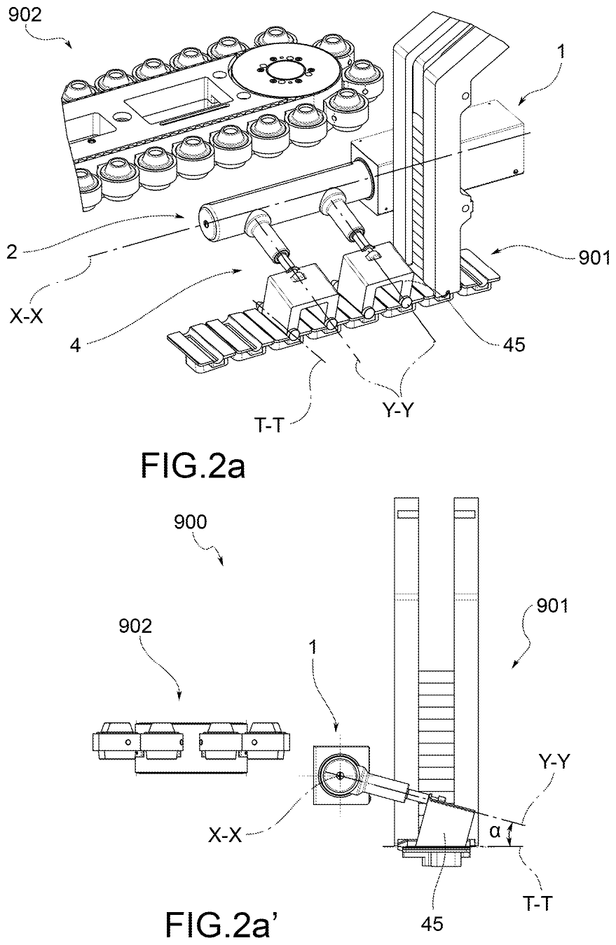

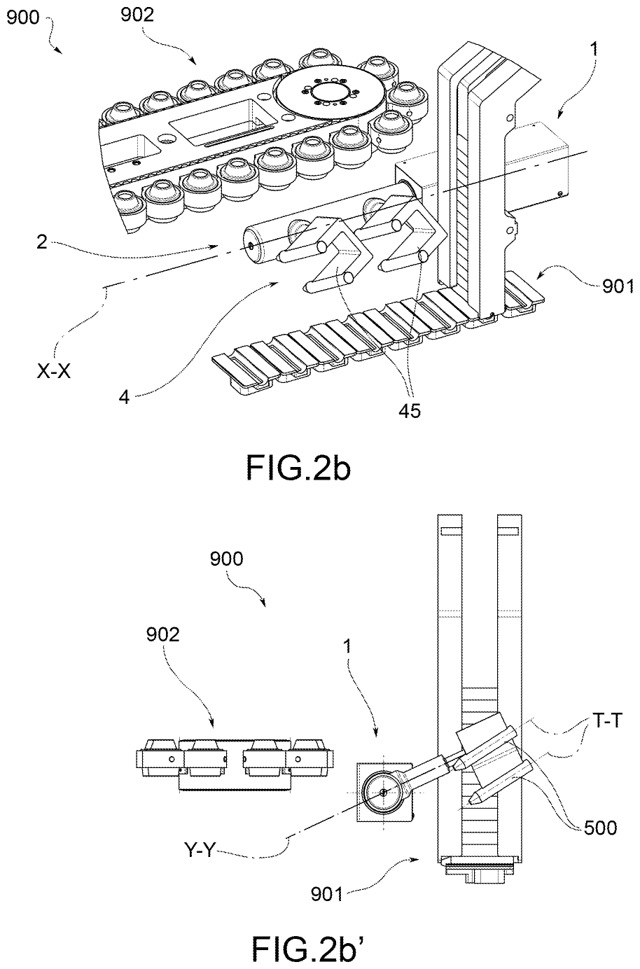

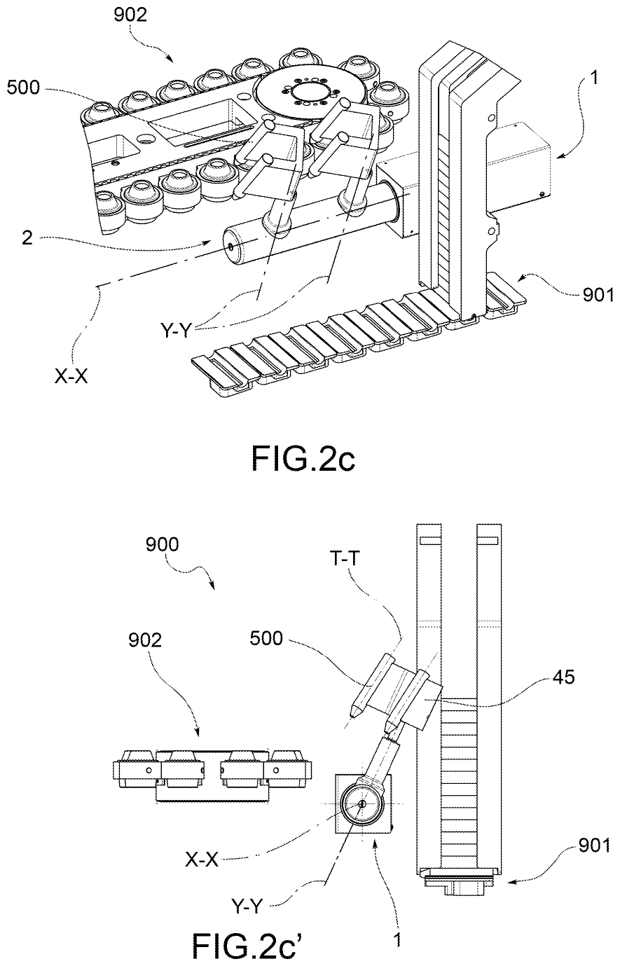

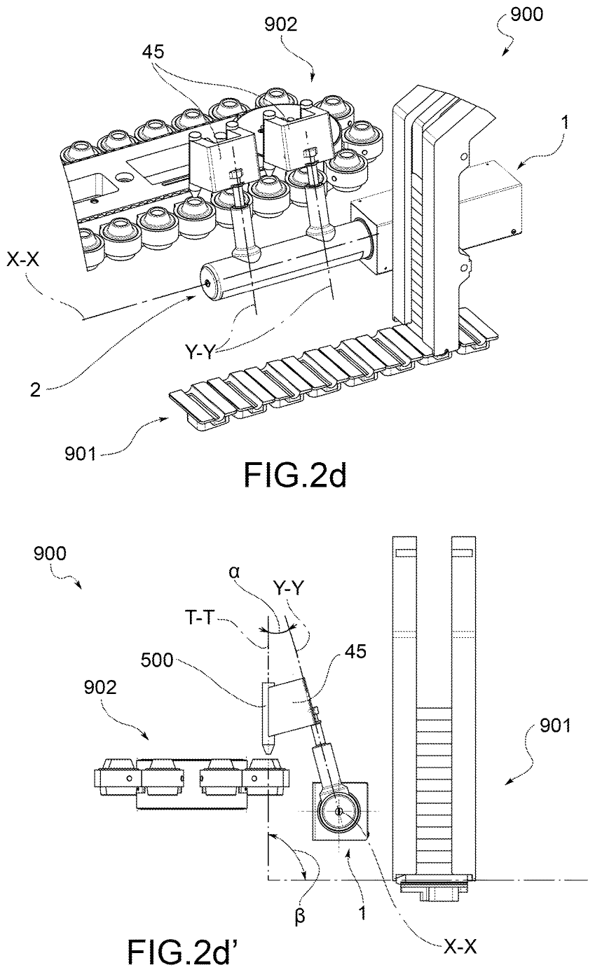

FIGS. 2a, 2b, 2c, and 2d show, in perspective, a plant, respectively in a first position (or picking position), a first intermediate position, a second intermediate position and a second position (or positioning position or depositing position) according to the present invention, according to a second embodiment;

FIGS. 2a′, 2b', 2c′ and 2d′ show some side views of the plant shown in FIGS. 2a, 2b, 2c and 2d;

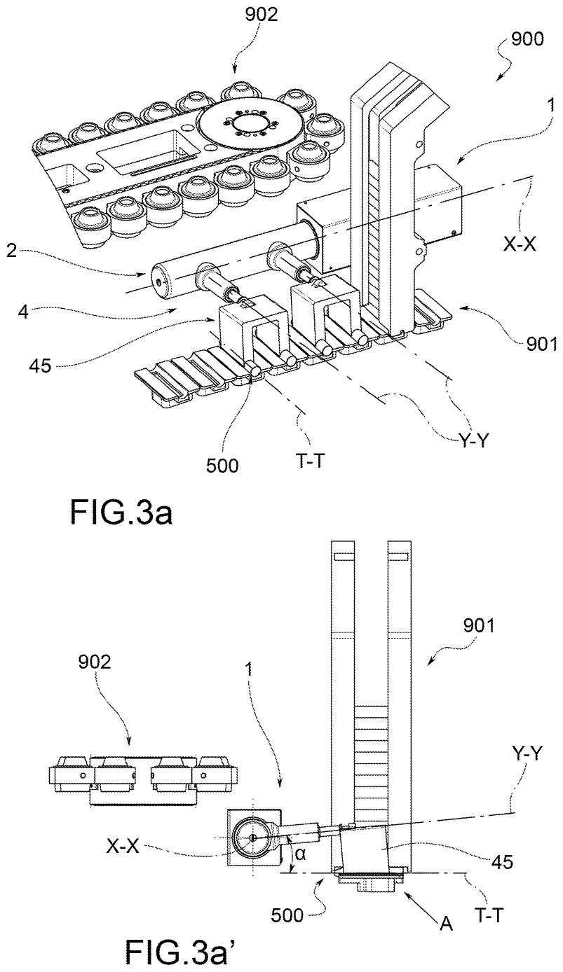

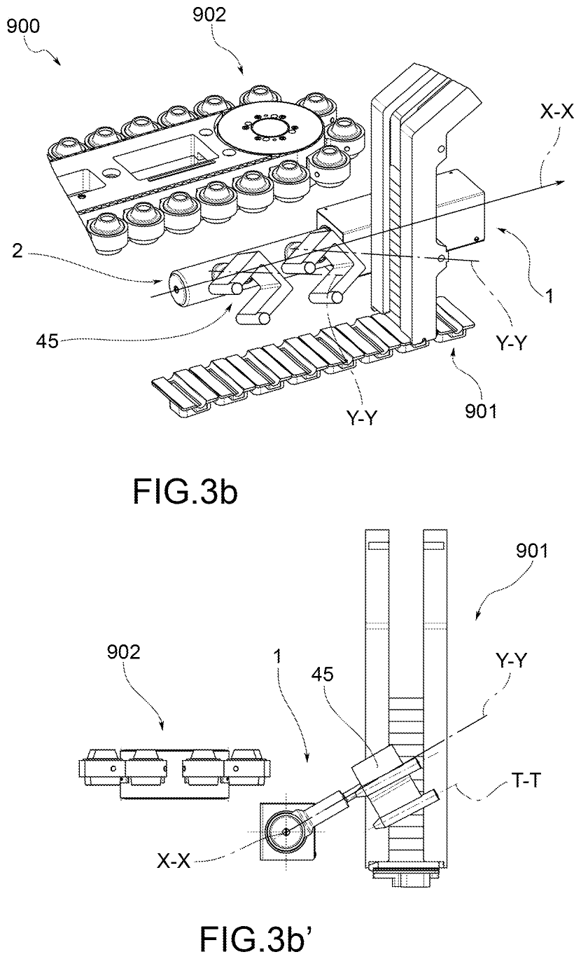

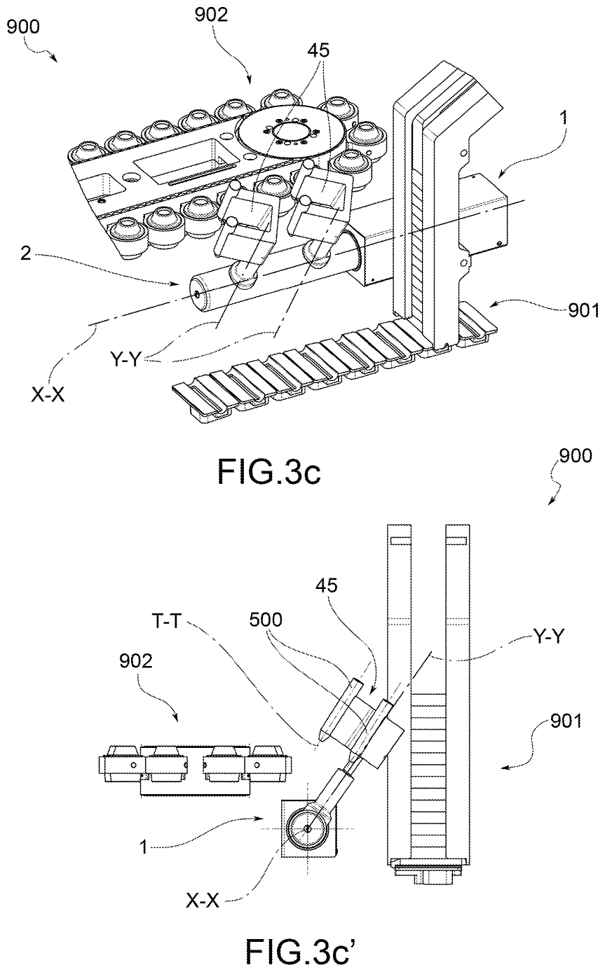

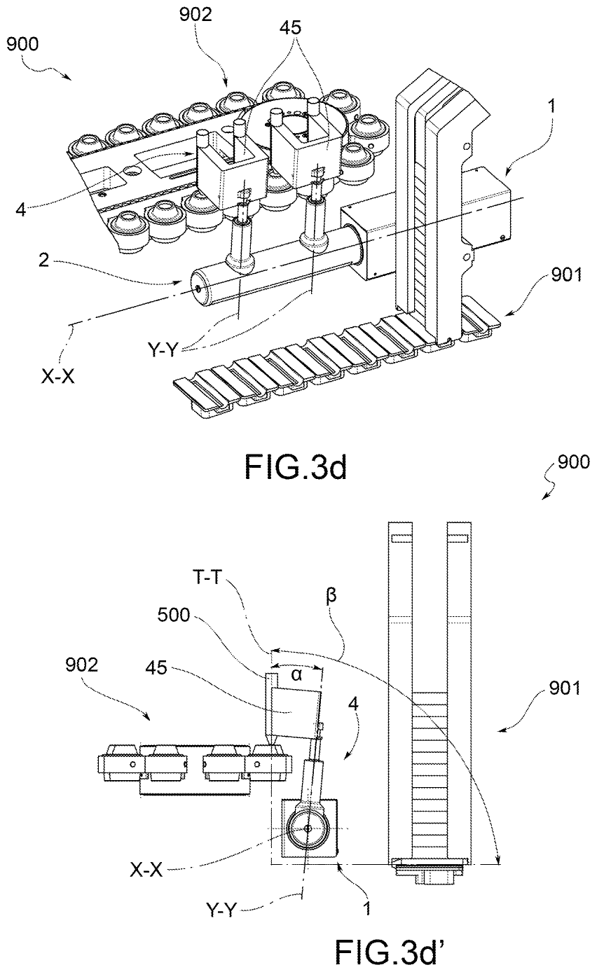

FIGS. 3a, 3b, 3c and 3d show, in perspective, a plant, respectively, in a first position (or picking position), a first intermediate position, a second intermediate position and a second position (or positioning position or depositing position) according to the present invention, according to a first embodiment;

FIGS. 3a′, 3b′, 3c′ and 3d′ show some side views of the plant shown in FIGS. 3a, 3b, 3c and 3d;

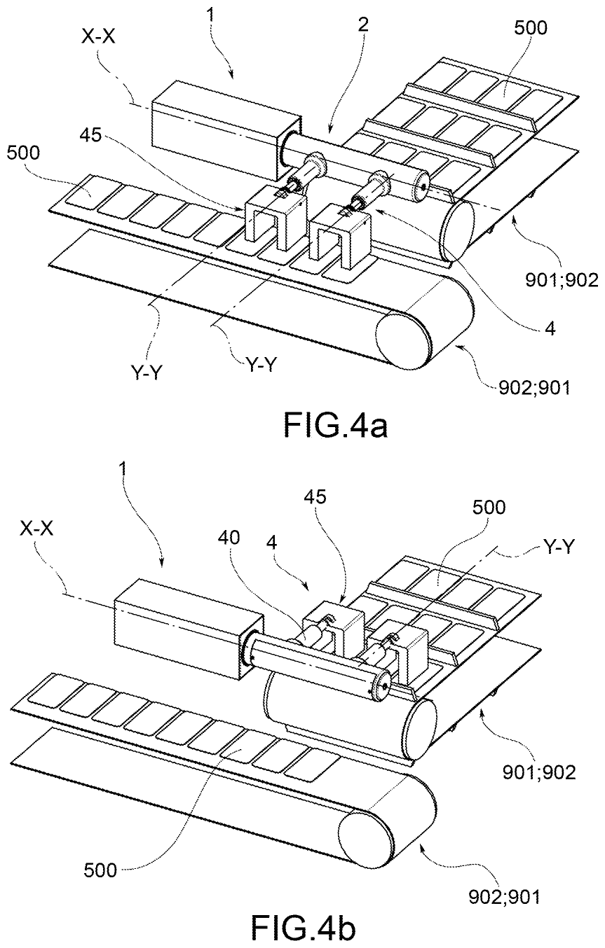

FIGS. 4a and 4b are perspective views of a plant, respectively in a first position (or picking position) and a second position (or positioning position or depositing £ position) according to the present invention, according to a fourth embodiment;

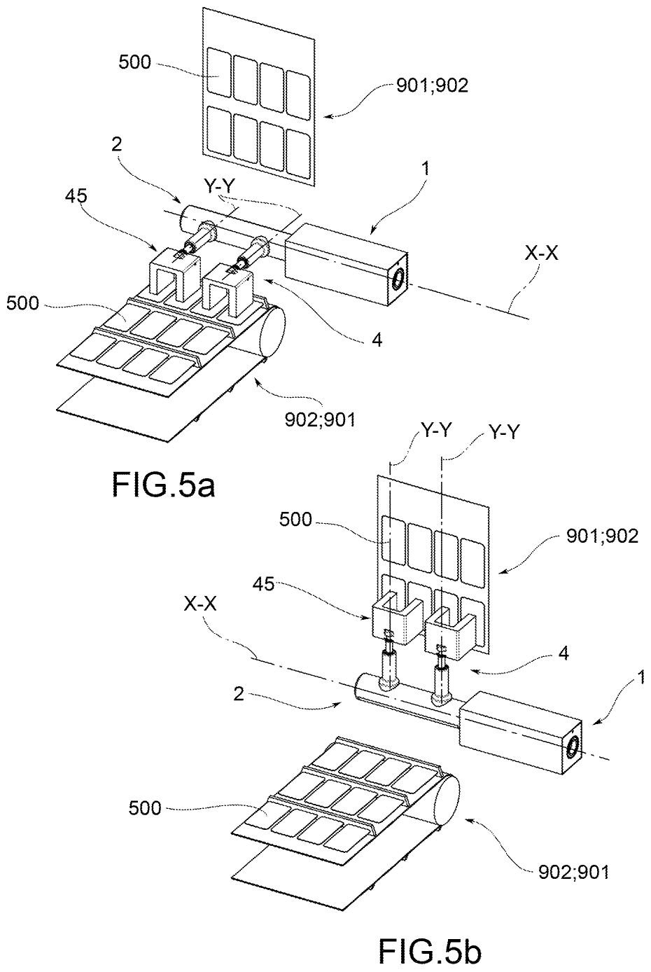

FIGS. 5a and 5b are perspective views of a plant, respectively in a first position (or picking position) and a second position (or positioning position or depositing position) according to the present invention, according to a fifth embodiment;

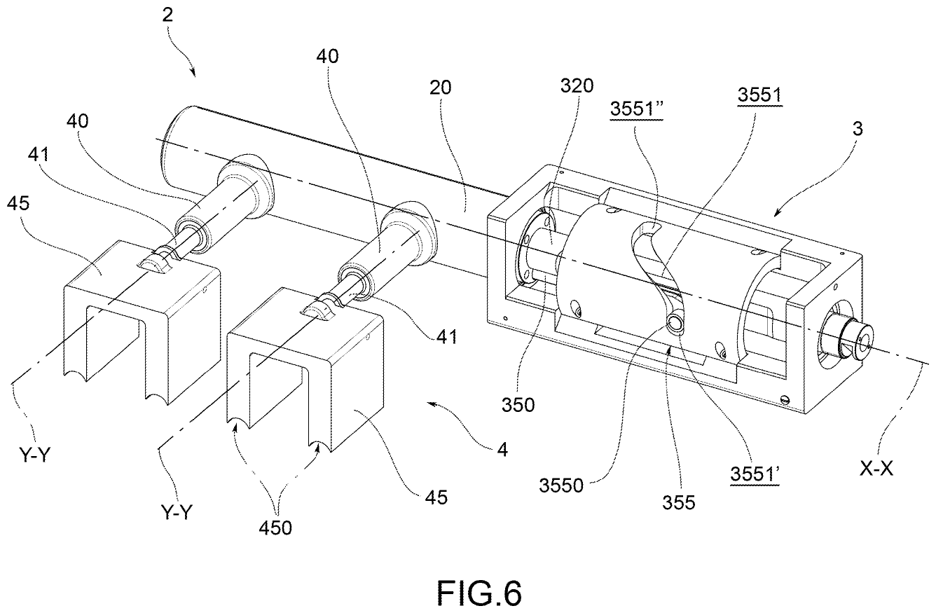

FIG. 6 is a perspective view of a picking and positioning system configured in a first position, according to a preferred embodiment, according to the present invention;

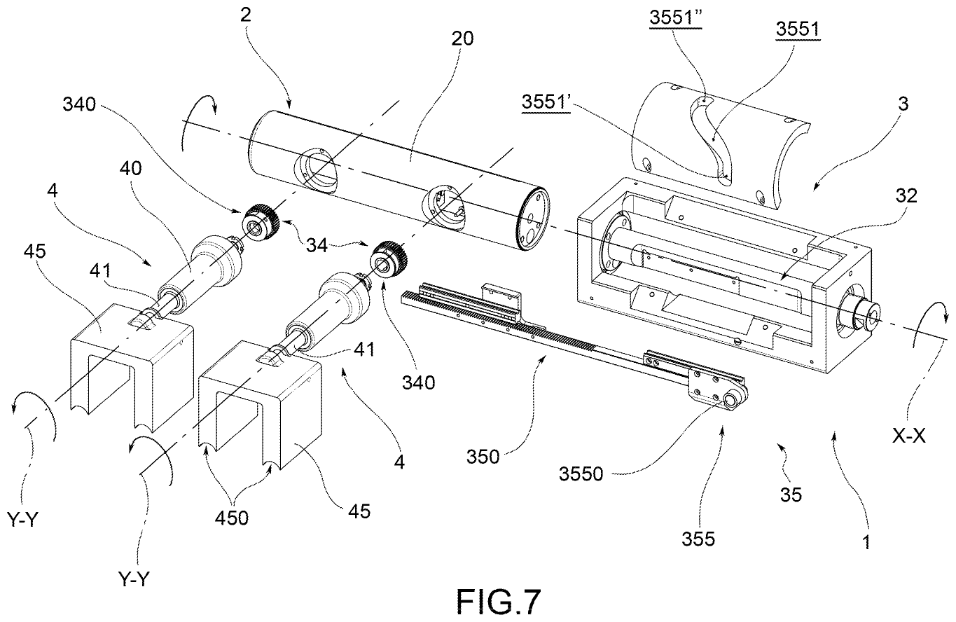

FIG. 7 is a perspective view, in separate parts, of the picking and positioning system of FIG. 6;

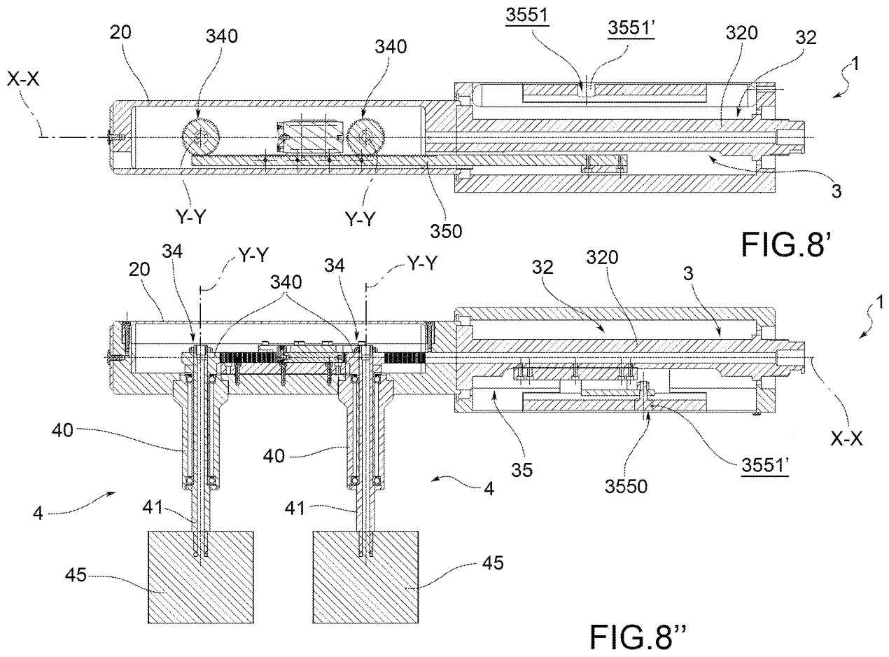

FIGS. 8′ and 8″ show the picking and positioning system of in FIG. 6, respectively in cross-section along a first axis and along a second axis;

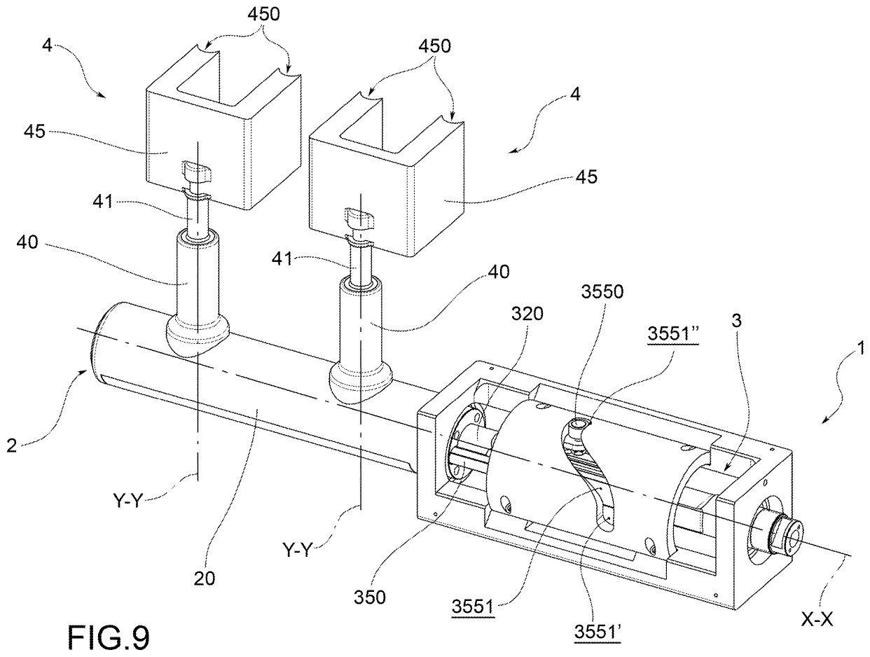

FIG. 9 is a perspective view of a picking and positioning system configured in a second position, according to a preferred embodiment, according to the present invention;

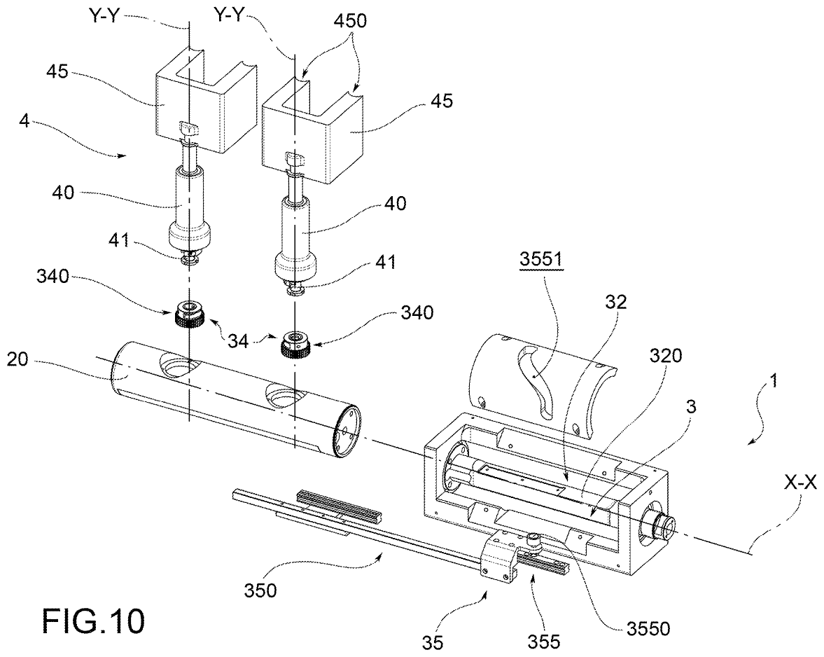

FIG. 10 is a perspective view, in separate parts, of the picking and positioning system shown in FIG. 9;

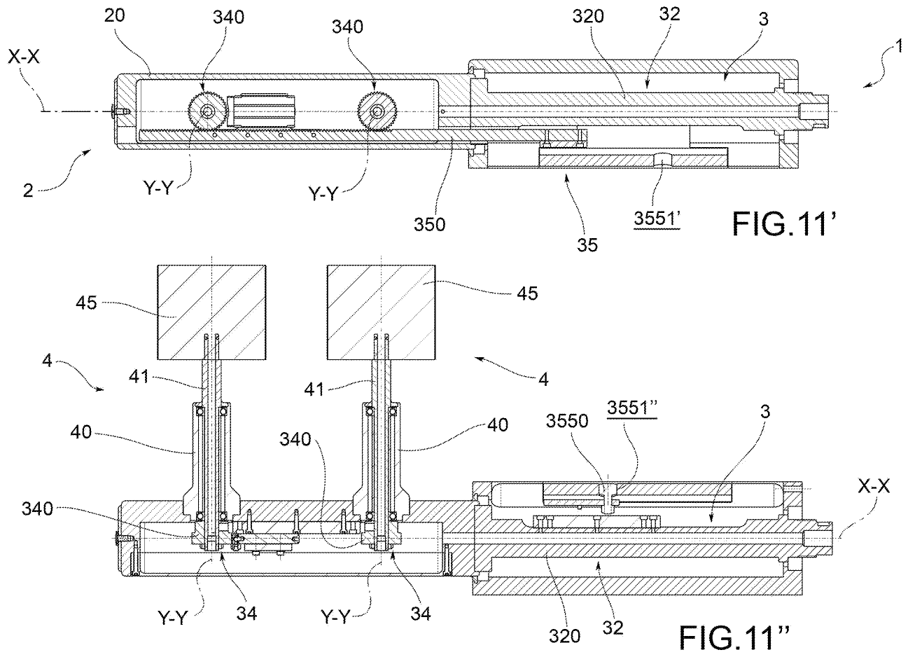

FIG. 11′ and 11″ show the picking and positioning system shown in FIG. 10, respectively in cross-section along a first axis and along a second axis;

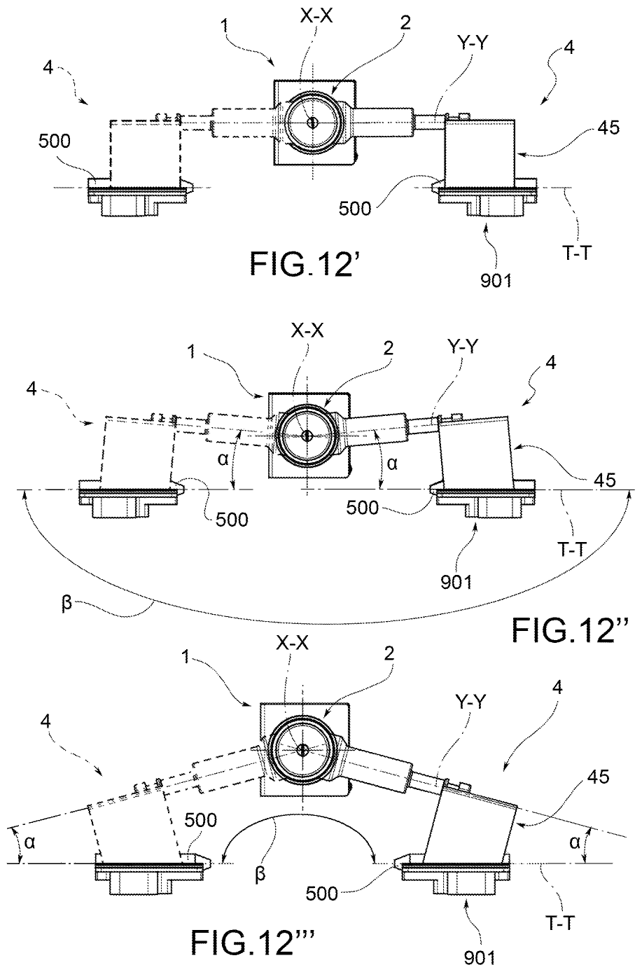

FIG. 12′, 12″ and 12′″ are schematic views of a plant according to another three preferred embodiments.

With reference to the appended figures, a picking and positioning system 1 of products is denoted with the numeral 1. Furthermore, the product is denoted by the numeral 500. Additionally, a plant is denoted by the numeral 900.

It should be noted that the shape and dimensions of the product 500 shown in the figures are indicative and are neither representative nor limiting.

According to a preferred embodiment, the product 500 has a shape elongated along a product axis T-T, as the axis with respect to which it extends longitudinally.

According to a preferred embodiment, the product 500 is shaped so as to have two main dimensions, for example with respect to an imaginary plane, extending along a product axis T-T, as the axis with respect to which said it extends longitudinally, and a transverse axis substantially orthogonal to the product axis T-T.

According to a preferred embodiment, the product 500 is a tube.

According to a preferred embodiment, the product 500 is a blister pack.

According to a preferred embodiment, the product 500 is an elongate sachet, also known as a stick pack.

According to a preferred embodiment, the product 500 is a flattened sachet.

According to a preferred embodiment, the product 500 is a substantially box-shaped element.

The picking and positioning system 1 is suitable for engaging in grip the products 500 positioned in a first position A in order to move them and position them in a second position B. Preferably, said first position A corresponds to the picking position. Preferably, said second position B corresponds to the positioning position or depositing position.

According to the present invention, the plant 900 of products 500 comprises a transport system 901 of said products 500 and an operating system 902 suitable for carrying out specific operations on said products 500.

Preferably, the transport system 901 moves the products 500, preferably singularly. In other words, the transport system 901 moves the products 500 following a singularization or discretization operation.

According to a preferred embodiment, the transport system 901 comprises a storage or accumulation area wherein a plurality of products 500 and a conveyor belt that grips the products 500 from the storage region one at a time or in rows or in aligned groups are housed.

In a preferred embodiment, the products 500 are moved by the transport system 901 into a substantially horizontal position with respect to the ground plane.

In other words, the products 500 are moved with the product axis T-T in a substantially horizontal position.

According to a further preferred embodiment, the products 500 are moved by the transport system 901 into a substantially vertical position in relation to the ground plane.

In other words, the products 500 are moved with the product axis T-T in a substantially vertical position.

Preferably, the operating system 902 is suitable for carrying out specific operations on the product 500, for example filling operations and closure/welding/gripping operations, operating near an end of the product 500.

Preferably, the product 500 in the operating system 902 is positioned in a substantially vertical position. In other words, the products 500 are the object of operations on the part of the operating system 902 with the product axis T-T in a substantially vertical position. For example, the operating system 902 comprises a pusher group suitable for carrying out a pushing action in a direction parallel or coincident to that of the product axis T-T.

According to other embodiments, the product 500 in the operating system 902 is positioned in a substantially horizontal position. In other words, the products 500 are the object of operations on the part of the operating system 902 with the product axis T-T in a substantially horizontal position.

According to the present invention, the plant 900 comprises the picking and positioning system 1 of the products 500 which grips a product 500 from the first position A, wherein the product 500 is substantially horizontal, and positions it in the second position B, wherein the product 500 is substantially vertical or vice versa.

According to a preferred embodiment, said first position A corresponds to the position of the products on the transport system 901. Preferably, in the first position A, the product 500 is in a substantially horizontal position.

According to a preferred embodiment, said second position B corresponds to the position of the products on the operating system 902. Preferably, in the second position B, the product 500 is in a substantially vertical position.

According to the present invention, the picking and positioning system 1 comprises:
a base group 2 comprising a base body 20, which extends along a first axis X-X, wherein said base body 20 is rotatably movable around said first axis X-X;
at least one gripping group 4, engaged to the base body 20, which extends along a second axis Y-Y, incident, preferably orthogonal, to the first axis X-X, comprising a gripping device 45 comprising at least one gripping element 450 which engages the product 500, wherein said gripping device 45 is rotatably movable around said second axis Y-Y;
command means 3 engaged to the base group 2 and the gripping group 4 to command them in movement and command the gripping element 450, and the product 500, from the first position A to the second position B.

According to a preferred embodiment, the base body 20 is a hollow element and elongated along the first axis X-X.

According to a preferred embodiment, the gripping group 4 comprises a gripping body 40. Preferably, the gripping body 40 is a hollow element and elongated along the second axis Y-Y. Preferably, the gripping body 40 extends between the base body 20 and the gripping device 45.

Preferably, the gripping body 40 is fastened to the base body 20 and suitable for providing support to the gripping device 45.

Preferably, the gripping device 45 also comprises a shaft 41 which extends, starting from the gripping element 41, along the second axis Y-Y, in part being housed with the gripping body 40.

According to a preferred embodiment, the gripping device 45 comprises two gripping elements 450 suitable for simultaneously engaging two products 500. Preferably, the two gripping elements 450 are equidistant from the respective second axis Y-Y.

According to a preferred embodiment variant, the gripping device 45 comprises three gripping elements 450 suitable for simultaneously engaging three products 500. Preferably, one gripping element 450 lies along the second axis Y-Y, whilst the other two are equidistant from the respective second axis Y-Y.

According to a preferred embodiment, the picking and positioning system 1 comprises a pneumatic assembly which is housed, at least partially, in the base body 20 and in the gripping body 40 fluidically connected with the gripping device 45. In other words, the base body 20 and the gripping body 40 extend specific pneumatic ducts. Preferably, the pneumatic assembly also extends into the shaft 41.

According to a preferred embodiment, the gripping device 45 engages the product 500 by carrying out a pneumatic suction action.

Preferably, the gripping element 450 has specific openings wherethrough air is sucked. The positioning of the said opening in the wall of a product therefore allows for gripping by means of a suction action that is by means of a pneumatic suction action.

Preferably, the gripping element 450 comprises a gripping portion suitable for directly coming into contact with the product 500. Preferably, said gripping portion is exchangeable as a function of necessity.

According to a preferred embodiment, the picking and positioning system 1 comprises at least two gripping groups 4 axially spaced apart along the first axis X-X.

According to a preferred embodiment, the rotation of the gripping group 4 is simultaneous with the rotation of the base group 2.

According to the present invention, the command means 3 comprise:
a first device 32 which moves in rotation the base body 20;
a second device 34 which moves in rotation the gripping group 4, in particular the gripping device 45;
transmission members 35 operatively connected with the first device 32 and with the second device 34, which transform the rotary action of the first device 32 into a rotary action of the second device 34.

Preferably, the first device 32 comprises a command shaft 320 which extends along the first axis X-X. Preferably, the command shaft 320 is engaged with an actuating group, for example, a motor, preferably an electric motor.

According to a preferred embodiment, the transmission members 35 comprise a rack 350 engaged to the first device 32 and to the second device 34.

Preferably, the rack 350 extends parallel to the first axis X-X.

Preferably, the rack 350 extends parallel to the command shaft 320.

According to a preferred embodiment, the second device 34 comprises a gear 340 engaged to the rack 350.

Preferably, said gear 340 is positioned centered on the second Y-Y axis.

According to a preferred embodiment, said gear 340 engages the shaft 41. With the rotation of the gear 340 there is a corresponding rotation of the shaft 41 and therefore of the gripping device 45.

According to a preferred embodiment, the transmission members 35 furthermore comprise a cam assembly 355 engaged to the rack 350. With the rotation of the first device 32, the cam assembly 355 moves, along the first axis X-X, the rack 350 which rotatably commands the second device 34.

According to a preferred embodiment, the cam assembly 355 comprises a pin 3550 fastened to the rack 350, and to a slot 3551, wherein the rotation of the first device 32 causes the pin 3550 to slide into the slot 3551.

According to a preferred embodiment, the slot 3551 comprises two end regions 3551′, 3551″.

Preferably, the first position A and the second position B of the picking and positioning system: correspond to the positioning of the pin 3550 in said end regions 3551′, 3551″, respectively.

According to a preferred embodiment, the rotary movement of the gripping device 45 with respect to the second axis Y-Y is a function of the shape of the slot 3551. As a function of the shape, and of the length of the slot 3551 the movement and the path of the gripping device 45 is in fact controlled. In other words, as a function of the shape and length of the slot 3551 the angle of rotation of the gripping device 45 is controlled respect to the second axis Y-Y. In other words, as a function of the shape and length of the slot 3551 the rotational speed of the gripping device 45 is controlled in relation to the second axis Y-Y.

According to a preferred embodiment, furthermore, the gripping element 450 is shaped in such a manner that gripped with a product 500, the second axis Y-Y and the product axis T-T are mutually incident with respect to an imaginary plane orthogonal to the first axis X-X, thus defining a gripping angle α.

According to a preferred embodiment, with the movement from the first position A to the second position B the product 500 carries out an angular stroke equal to a movement angle β, whilst the base group 2 carries out a rotation around the first axis X-X with an angular stroke equal to the movement angle β less twice the gripping angle α.

Preferably, the base group 2 carries out a rotation around the first axis X-X with a stroke of 90° less twice the gripping angle α.

Preferably, the base group 2 carries out a rotation around the first axis X-X with a stroke of 180° less twice the gripping angle α.

According to a preferred embodiment, with the movement from the first position A to the second position B the product 500 carries out an angular stroke equal to a movement angle β, whilst the base group 2 carries out a rotation around the first axis X-X with an angular stroke equal to the movement angle β plus twice the gripping angle α.

Preferably, the base group 2 carries out a rotation around the first axis X-X with a stroke of 90° plus twice the gripping angle α.

Preferably, the base group 2 carries out a rotation about the first axis X-X with a stroke of 180° plus twice the gripping angle α.

According to a preferred embodiment, as a function of the gripping angle α, the movement trajectory of the product 500 varies.

Preferably, as a function of the type of product 500, a predefined gripping angle α corresponds.

According to a preferred embodiment, the engagement of the gripping element 450 to the product 500 is such as to ensure an elevated contact surface, thus facilitating the gripping thereof.

According to a preferred embodiment, the picking and positioning system 1 is positioned within the plant 900 in such a manner to have the first axis X-X at a lower height than the product 500 positioned in the second position B.

Preferably, the picking and positioning system 1 is positioned within the plant 900 in such a manner to have the first axis X-X at a height which is equal to or lower than the product 500 positioned in the first position A.

Preferably, the picking and positioning system 1 is designable in such a manner to have all of the transmission members at a substantially lower position than the product 500. In particular, the picking and positioning system 1 is presented in such a manner to be positioned lower than the upper end, preferably open, of the product 500.

According to a preferred embodiment, the gripping angle α affects the movement stroke of the product 500.

Innovatively, the picking and positioning system and the plant fully fulfill the intended purpose in overcoming the typical problems of the prior art.

Advantageously, in fact, the picking and positioning system makes it possible to achieve all of the requirements of the sector.

Advantageously, the picking and positioning system carries out identically reproducible movements over time.

Advantageously, the picking and positioning system carries out movements with elevated precision thus always ensuring precise positioning both in the first position and the second position.

Advantageously, the picking and positioning system carries out movements ensuring an elevated level of cleanliness and safety. Advantageously, the picking and positioning system finds application in the pharmaceutical, ensuring sector, ensuring an elevated level of cleanliness of the products.

Advantageously, the picking and positioning system results in being extremely flexible: it is in fact extremely simple to adapt the picking and positioning system, and in particular the movements thereof as a function of various product topologies.

Advantageously, in designing and appropriately choosing the slot, and in particular the shape and dimensions thereof, the product movement trajectory is modifiable.

Advantageously, in designing and appropriately choosing the gripping angle the product movement trajectory is modifiable.

Advantageously, the picking and positioning system is suitable for occupying minimal space within the plant.

Advantageously, the picking and positioning system is positionable, without any particular problems, either partially or completely, in a position covered by the transport system and/or by the operating system. Advantageously, the picking and positioning system is positionable, without any particular problems, within a smaller spatial region than the other systems of the plant or within a larger spatial region than the other systems of the plant.

Advantageously, the transport system and the operating system are positionable mutually proximal therebetween or else mutually distal therebetween, designing for the best the picking and positioning system, for example in choosing the form of the gripping device.

Advantageously, the plant is designable as a function of requirements in taking advantage of the design versatility of the picking and positioning system.

Advantageously, the picking and positioning system is suitable for operating with products of different lengths. Advantageously, the height and the dimensions of a product are not a limit for the picking and positioning system.

It is clear that a person skilled in the art may make changes to the invention described above in order to meet contingent needs, which changes all fall within the scope of protection as defined in the following claims.

1. A picking and positioning system of products for a plant, comprising a transport system and an operating system, wherein the picking and positioning system is suitable for engaging in grip the products positioned in a first position, to move and position the products in a second position, wherein the picking and positioning system comprises:
a base group comprising a base body which extends along a first axis, wherein base body is rotatably movable around the first axis;
at least one gripping group, engaged to the base body, which extends along a second axis, incident preferably orthogonal, to the first axis, comprising a gripping device comprising at least one gripping element which engages a product, wherein the gripping device is rotatably movable around the second axis; and
command means engaged to the base group and the at least one gripping group to command the base group and the at least one gripping group in movement and command the at least one gripping element, and the product, from the first position to the second position, comprising:
a first device which moves in rotation the base body;
a second device which moves in rotation the at least one gripping group; and
transmission members operatively connected to the first device and the second device, which transform a rotary action of the first device into a rotary action of the second device so that a rotation of the at least one gripping group is simultaneous with a rotation of the base group.

2. The picking and positioning system of claim 1, wherein the transmission members comprise a rack engaged with the first device and the second device and a cam assembly engaged with the rack, and wherein upon a rotation of the first device, the cam assembly moves the rack, which rotatably commands the second device, along the first axis.

3. The picking and positioning system of claim 2, wherein the cam assembly comprises a pin fastened to the rack and a slot, and wherein the pin slides into the slot upon the rotation of the first device.

4. The picking and positioning system of claim 3, wherein the slot comprises two end regions, wherein the first position and the second position of the picking and positioning system correspond to a positioning of the pin in said end regions, respectively.

5. The picking and positioning system of claim 4, wherein a rotary movement of the at least one gripping group is a function of a shape and a length of the slot.

6. The picking and positioning system of claim 1, wherein the picking and positioning system picks a product from the first position in which the product is substantially horizontal and positions the product in the second position in which the product is substantially vertical, or vice versa.

7. The picking and positioning system of claim 1, comprising at least two gripping groups axially spaced apart along the first axis.

8. The picking and positioning system of claim 1, wherein the at least one gripping group comprises a gripping body extending along the second axis between the base body and the gripping device, and wherein the command means are engaged with and/or partially housed in the base body and the gripping body.

9. The picking and positioning system of claim 1, wherein the at least one gripping element is shaped in such a manner that gripped with the product, the second axis and the product axis are mutually incident with respect to an imaginary plane orthogonal to the first axis, thus defining a gripping angle.

10. The picking and positioning system of claim 9, wherein, in a movement from the first position to the second position, the product carries out a movement equal to a movement angle, whilst the base group carries out a rotation around the first axis with an angular stroke equal to the movement angle less twice the gripping angle or with an angular stroke equal to the movement angle plus twice the gripping angle.

11. The picking and positioning system of claim 1, wherein the gripping device comprises two gripping elements suitable for simultaneously engaging two products.

12. The picking and positioning system of claim 1, wherein the gripping device engages the products by carrying out a pneumatic suction action.

13. The picking and positioning system of claim 12, wherein the at least one gripping group comprises a gripping body extending along the second axis between the base body and the gripping device, wherein the command means are engaged with and/or partially housed in the base body and the gripping body, and wherein the picking and positioning system further comprises a pneumatic assembly which is housed in the base body and in the gripping body fluidically connected with the gripping device.

14. A plant comprising a transport system of products, and an operating system suitable for carrying out specific operations on the products, wherein the plant comprises the picking and positioning system of claim 1, and wherein the first position is on the transport system and the second position is on the operating system.

15. The plant of claim 14, wherein the picking and positioning system picks a product from the first position in which the product is substantially horizontal and positions the product in the second position in which the product is substantially vertical, or vice versa.

16. The plant of claim 14, wherein the picking and positioning system is positioned in such a manner to have the first axis at a lower height than the product positioned in the second position.

17. The plant of claim 16, wherein the picking and positioning system is positioned in such a manner to have the first axis a height equal to or lower than the product positioned in the first position.

18. The picking and positioning system of claim 1, wherein the first position is on the transport system and the second position is on the operating system.

19. The picking and positioning system of claim 1, wherein the second device moves in rotation the gripping device.

20. The plant of claim 14, wherein the transport system moves the products singularly.
